(19) United States
(12) Patent Application Publication
(10) Pub. No.: US 2009/0314138 A1
(43) Pub. Date: Dec. 24, 2009

(54) MULTI-DRIVER RATCHETING HAND TOOL

(75) Inventors: Joseph T. Zachariasen, Ashland, OR (US); Steven J. Miner, Ashland, OR (US)

Correspondence Address: FELLERS, SNIDER, BLANKENSHIP, BAILEY & TIPPENS, PC, 100 NORTH BROADWAY, SUITE 1700, OKLAHOMA CITY, OK, 73102-8820, US

(73) Assignee: PROFESSIONAL TOOL MANUFACTURING, LLC, Ashland, OR (US)

(21) Appl. No.: 12/280,332

(22) PCT Filed: Feb. 23, 2007
(86) PCT No.: PCT/US07/04728

§ 371 Date: Aug. 13, 2009

Related U.S. Application Data
(60) Provisional application No. 60/776,030, filed on Feb. 23, 2006.
(60) Provisional application No. 60/846,533, filed on Sep. 22, 2006.

(51) Int. Cl. B25B 23/16; B25B 13/46

(52) U.S. Cl. 81/60; 81/440; 81/177.7

(57) ABSTRACT

Apparatus for engaging a mechanical component, such as a fastener. A handle portion (102, 174) is hingedly affixed to a ratchet mechanism (108, 180). A tool holder support structure (110, 140, 150, 160, 174) is aligned with and rigidly affixed to the ratchet mechanism opposite the handle portion. A tool holder (112, 142, 152, 162, 176) is supported by the tool holder support structure and comprises opposing first and second ends (114, 116) each configured to support at least one respective tool (118, 132, 178, 220, 222, 224, 226, 228, 230, 232). The tool holder preferably rotates with respect to the tool holder support structure about a pivot (129, 146, 210). Preferably, the handle portion and ratchet mechanism are removable to permit a separate driver (196) to impart torque to a selected extended tool. The handle portion is further preferably moveable from an open position to a folded, closed position.

### BACKGROUND

Hand tools are used in a variety of applications to engage mechanical components, such as fasteners. A variety of fastener driver configurations are well known in the art, such as flat and Philips screwdriver patterns, socket heads, hex key wrench channels, etc.

Multi-tool devices have been proposed in the art to incorporate a quantity of different sized driver elements that can be individually selected by the user for a particular application. While operable, there remains a continued need for improvements in the art that accommodate a quantity of drivers which can be quickly and efficiently selected and used.

### SUMMARY

Preferred embodiments of the present invention are generally directed to an apparatus for engaging a mechanical component, such as a fastener.

In accordance with preferred embodiments, the apparatus comprises a handle portion hingedly affixed to a ratchet mechanism, a tool holder support structure aligned with and rigidly affixed to the ratchet mechanism opposite the handle portion, and a tool holder supported by the tool holder support structure. The tool holder comprises opposing first and second ends each configured to support at least one respective tool.

The tool holder preferably rotates with respect to the tool holder support structure about a pivot. Preferably, the handle portion and ratchet mechanism are removable to permit a separate driver to impart torque to a selected extended tool. The handle portion is further preferably moveable from an open position to a folded, closed position.

### BRIEF DESCRIPTION OF THE DRAWINGS

FIG. 1 provides an elevational representation of a ratchet tool assembly constructed in accordance with preferred embodiments of the present invention.

FIG. 2 shows the ratchet tool assembly of FIG. 1 in a folded (closed) position.

FIG. 3 illustrates a preferred manner in which individual drivers are selected by a user.

FIGS. 4-6 generally illustrate a preferred sequence whereby a tool holder of the assembly is pivoted to allow access to drivers at opposing ends of the tool holder.

FIG. 7 provides an alternative preferred embodiment in which a driver bit is inserted into a corresponding channel at a selected end of the tool holder.

FIG. 8 shows another alternative preferred embodiment for the tool holder.

FIGS. 9-12 show a preferred manner in which opposing ends of the tool holder of FIG. 8 are selectively presented for use.

FIGS. 13-14 provide yet another depiction of a preferred embodiment in which the tool holder laterally engages a tool holder structure of the ratchet tool assembly.

FIGS. 15-16 provide still another depiction of a preferred embodiment in which the tool holder axially engages the tool holder structure.

FIG. 17 generally illustrates another ratchet tool assembly constructed in accordance with preferred embodiments of the present invention.

FIG. 18 depicts the ratchet tool assembly of FIG. 17 in an open position.

FIG. 19 illustrates a preferred construction for a removable handle of the assembly of FIGS. 17-18.

FIG. 20 shows a preferred construction for a tool holder structure of the assembly of FIGS. 17-18.

FIG. 21 shows a preferred construction for a tool holder preferably supported by the structure of FIG. 20.

### DETAILED DESCRIPTION

Additional details are provided in the priority documents U.S. Provisional Patent Application Nos. 60/776,030 and 60/846,533, both of which are hereby incorporated by reference.

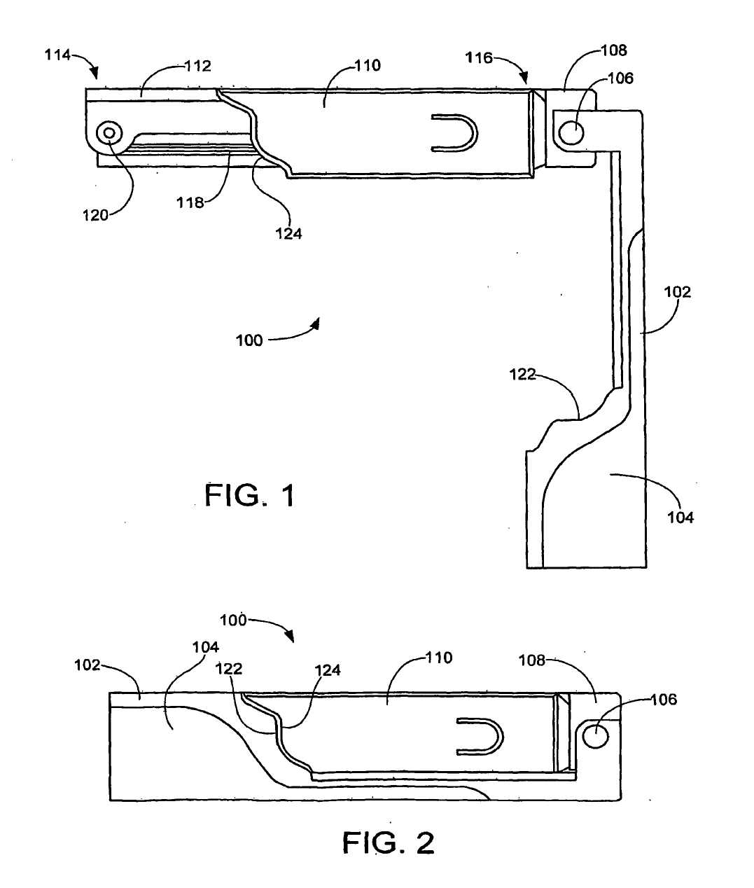

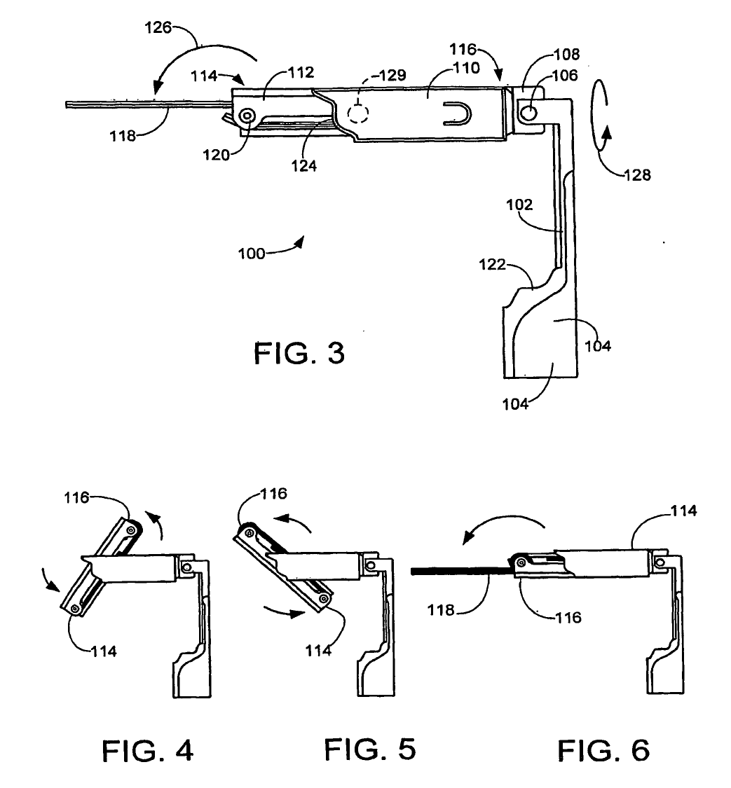

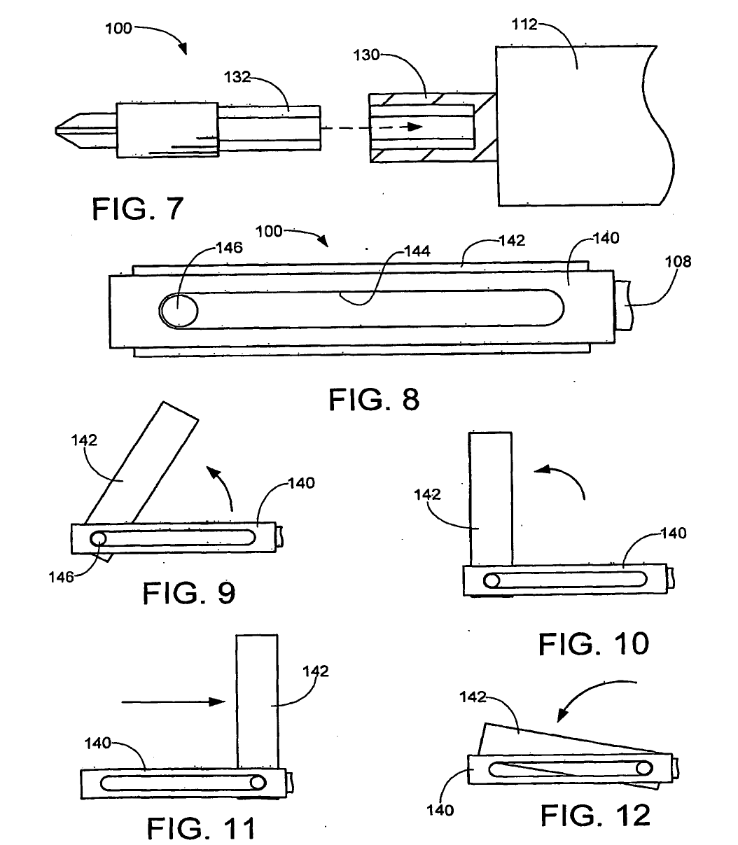

FIG. 1 generally depicts an exemplary ratchet tool assembly 100 constructed in accordance with preferred embodiments of the present invention. The assembly 100 includes a handle portion 102 (hereinafter “handle”) sized to accommodate a human hand. An external layer of rubber or similar elastomeric material 104 is preferably applied to enhance comfort and grip. A laterally extending pivot pin 106 facilitates hinged articulation of the handle 102 with respect to a ratchet mechanism 108.

The ratchet mechanism 108 is preferably selectable by the user to permit the application of torque in each of two opposite rotational directions of the handle 102. The internal configuration of the ratchet mechanism 108 is preferably of a conventional type, so no further discussion thereof is necessary.

A tool holder support structure 110 is rigidly affixed and axially aligned with the ratchet mechanism 108 opposite the handle 102. The support structure 110 is configured to support a tool holder 112 (partially visible in FIG. 1). The tool holder 112 has opposing first and second ends 114, 116 each configured to support at least one tool. In the embodiment shown, a number of hex wrench drivers 118 are hingedly affixed to each end (e.g., the drivers at the first end 114 are hinged via a lateral pin 120, although other arrangements could readily be used).

The handle 102 is preferably substantially u-shaped to accommodate nesting of the support structure 110 and tool holder 112 therein, as shown in FIG. 2. This is carried out by folding the assembly 100 about the pin 106 to place the assembly 100 in a closed position during storage. The handle 102 preferably includes a pair of opposing, irregular mating surfaces 122 that mirror mating surfaces 124 of the support structure 124. These respective surfaces 122, 124 align as shown in FIG. 2 and facilitate operation of the user to unfold the assembly 100 to the open position of FIG. 1.

A selected hex key wrench driver 118 is shown in an extended position in FIG. 3 from the first end 114 of the tool holder 112. The selected driver 118 is preferably extended through pivotal advancement by the user as indicated by arrow 126. The distal end of the selected driver 118 is in substantial axial alignment with the ratchet 108 so that the application of torque to the laterally extending handle 102, such as denoted by arrow 128, results in a corresponding rotation of the distal end of the driver 118. It will be noted that the ratchet mechanism 108 preferably allows a free-wheeling (non-application of torque) when the handle 102 is rotated in the direction opposite that of arrow 128.

It is contemplated that the respective drivers 118 will preferably extend from each end 114, 116 in facing parallel relationship within the confines of the tool holder 112 when not in use. The tool holder 112 is preferably pivotally supported via an interior pin 129 (shown in broken line fashion in FIG. 3) near a medial portion of the tool holder 112. In this way, a driver 118 from the second end 116 can be presented for use by the sequence shown in FIGS. 4-6. As desired, a detent or similar latching mechanism (not separately shown) can be used to retain the tool holder 112 in the desired parallel orientations of FIGS. 3 and 6.

While the use of opposing hinged hex key wrench drivers 118 is preferred, in an alternative preferred embodiment at least one of the ends of the tool holder 112 is provisioned with a socket channel 130 to accommodate the insertion of individual driver bits, such as a Philips driver bit 132 as shown. Preferably, the tool holder 112 is configured to store a plurality of such bits with different driver characteristics. Magnetic coupling or similar techniques can be employed as desired to retain the inserted bits 132.

In a preferred embodiment, a number of hinged drivers (such as the hex wrench drivers 118 of FIG. 1) are provisioned at one end of the tool holder 112 and the socket channel 130 is provisioned at the other end. Although not shown, it will be appreciated that any number of alternative and/or additional driver coupling mechanisms can be incorporated as desired, including a male box socket extension, drivers that are configured to slide in and out of the selected end, etc.

FIG. 8 provides a simplified schematic representation of an alternative preferred embodiment for the assembly 100. A tool holder support structure 140 is coupled to the ratchet mechanism 108 as before, and supports a tool holder 142.

The support structure includes opposing elongated channels 144. Laterally extending pins 146 from the tool holder 142 extend into the channels 144 for sliding engagement therewith. Although not explicitly shown in FIG. 8, it will be understood that internal support features are provided to facilitate support of the tool holder 142 along the length thereof by the support structure 140.

As before, drivers (not shown) are configured to extend from the opposing ends of the tool holder 142 for rotational activation via the ratchet 108. To switch the lateral orientation of the tool holder 142, the user manipulates the tool holder 142 as shown by the sequence of FIGS. 9-12.

More particularly, the tool holder 142 is first preferably brought into an upright (normal) orientation (FIGS. 9-10). The tool holder 142 is next translated axially along the length of the support structure 140 by way of sliding engagement of the pins 146 with channels 144 (FIG. 11). Finally, the tool holder 142 is folded back down (FIG. 12) to again extend along the axial length of the support structure 140. By reversing the sequence shown in FIGS. 9-12, either end of the tool holder 142 can be selectively presented for use.

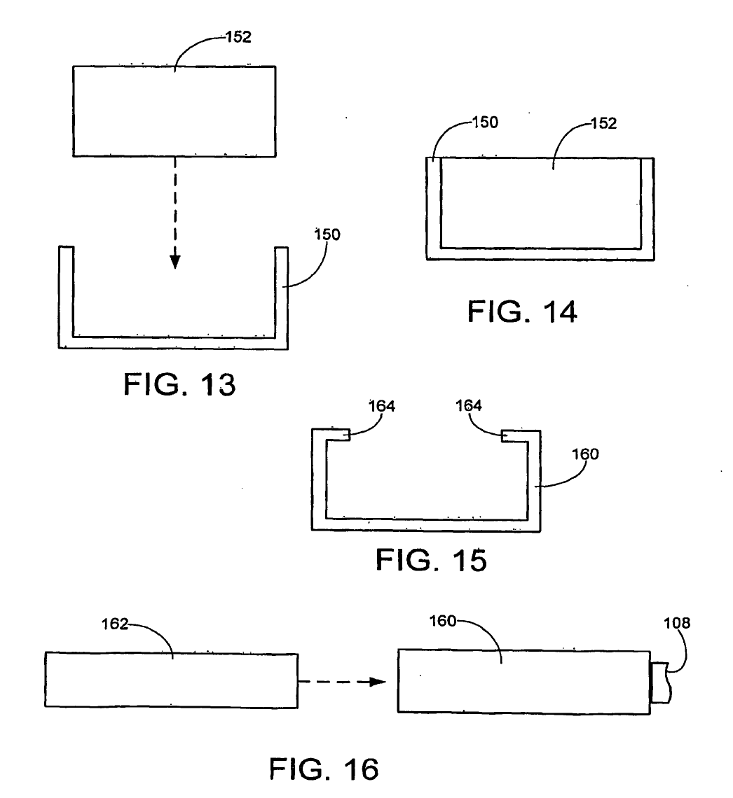

FIG. 13 is a simplified representation to provide yet another alternative embodiment for the ratchet tool assembly 100. For reference, the view in FIG. 13 is an end view normal to that of FIG. 8 so that the view is down the length of the support structure (denoted at 150). The support structure 150 is shown to preferably have a generally u-shaped cross-section to accommodate lateral engagement of a corresponding tool holder 152 therein, as shown by FIG. 14. A suitable latching mechanism (not shown) is preferably employed to retain the tool holder 152 within the support structure 150.

As before, the tool holder 152 is preferably configured to support a plurality of different drivers at each opposing end. To present a selected end for use, the user need merely remove the tool holder 152 from the support structure 150, manually rotate the tool holder 152, and then reinsert the tool holder 152 into the support structure 150. An advantage of this approach is the ability to provide different tool holders with different driver configurations (cartridges) that then can be inserted as required. Of course, this ability to insert different tool holders is not limited to the embodiment of FIGS. 13-14, but rather can readily be incorporated into the other preferred embodiments set forth herein.

FIG. 15 provides still another alternative embodiment for the support structure (denoted at 160). The support structure 160 is generally similar to the support structure 150, except that the corresponding tool holder (denoted at 162) is preferably inserted axially, as shown by FIG. 16. Retention flanges 164 (FIG. 15) can be provided as desired to retain and guide the tool holder 162 into supporting engagement with the support structure 160. As before, a latching mechanism is preferably utilized to retain the tool holder 162, and the user can selectively present either end of the tool holder 162 by removing, rotating, and replacing the tool holder 162.

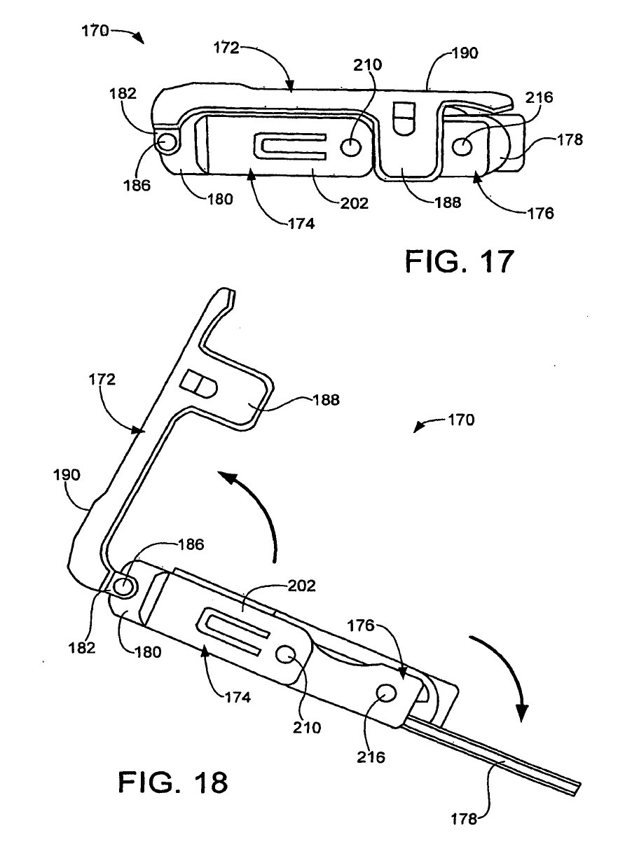

FIGS. 17-18 generally illustrate another ratchet tool assembly 170 constructed in accordance with preferred embodiments of the present invention. The assembly 170 is shown in a closed (folded) position in FIG. 17, and in an open position in FIG. 18.

The assembly 170 generally includes a handle assembly 172 (hereinafter “handle”), a tool holder support structure 174 and a tool holder 176. The handle 172 is preferably configured to be removable from the tool support structure 174 to enable a user to engage the assembly 170 using a separate socket driver or similar driving tool. As before, the tool holder 176 is rotatable with respect to the support structure 174 to allow extension of a selected tool, such as hex key wrench 178 shown in FIG. 18.

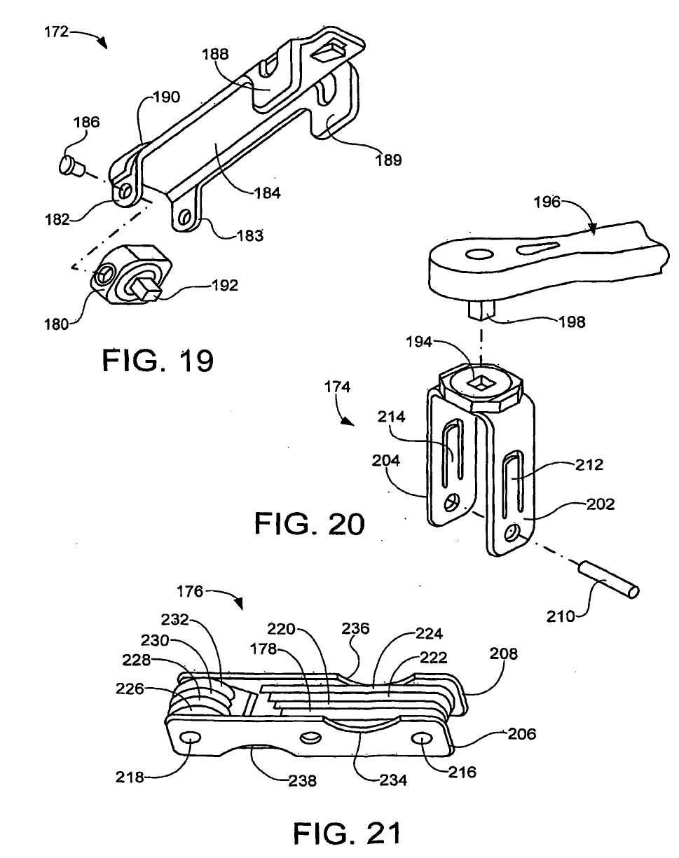

As further shown in FIG. 19, the handle 172 includes a ratchet mechanism 180 to enable the user to impart torque to the extended tool in either of two opposing selectable directions. The ratchet mechanism 180 is preferably supported by a pair of support flanges 182, 183 that extend from a main body portion 184 of the handle 172.

The support flanges 182, 183 accommodate fasteners (one shown at 186) which serve to secure the ratchet mechanism 180 to the body portion 184, while at the same time allowing rotation of the body portion 184 with respect to the ratchet mechanism 180 as the handle is moved between the open and closed positions of FIGS. 17-18.

A pair of user grippable flanges (tangs) 188, 189 preferably extend from the body portion 184 to facilitate user manipulation of the handle 172. A suitable coating, such as an elastomeric layer 190, can be applied to the handle 172 as desired to enhance user comfort during operation.

The ratchet mechanism 180 preferably includes a square driving head 192 (FIG. 19) which engages a corresponding socket aperture 194 of the tool holder support structure 174 (FIG. 20). A locking mechanism such as a detent ball (not shown) can be used to enhance the retention force between the head 192 and the aperture 194. Upon removal of the handle 172, a separate driver tool such as socket driver 196 can be used to impart torque to the support structure 174 via insertion of a driving head 198 of the socket driver 196 into the aperture 194.

As shown in FIG. 20, the tool holder support structure 174 is preferably u-shaped with base portion 200 and opposing leg portions 202, 204. The aperture 194 extends through the base portion 200 as shown. The leg portions 202, 204 respectively engage a medial portion of the tool holder 176 to allow each of the respective ends of the tool holder 176 to be rotatably extended away from the support structure 204.

While the tool holder support structure 174 is preferably u-shaped, such is not limiting; rather, any suitable configuration for the support structure can be utilized as desired. Moreover, while the socket aperture 194 is preferably square shaped, any number of different shapes can be used.

FIG. 21 shows a preferred construction for the tool holder 176. Opposing rail supports 206, 208 extend along the length of the tool holder 176 to abut the respective leg portion 202, 204 of the support structure 174. A pivot pin 210 (FIG. 20) extends through associated apertures in the leg portions 202, 204 and the rail supports 206, 208 to rotatably mount the tool holder 176 to the support structure 174. Detent tabs 212, 214 on the leg portions 202, 204 preferably engage the rail supports 206, 208 to nominally bias the tool holder 176 in axial alignment with the support structure 174.

Hinge pins 216, 218 extend from the rail support 206 to the rail support 208 at opposing ends of the tool holder 174. The pin 216 supports and facilitates rotational extension of the hex key wrench 178 of FIG. 18, as well as adjacently disposed wrenches 220, 222 and 224. The wrenches 178, 220, 222 and 224 preferably lay across a top portion of the tool holder 176 when not in use.

The pin 218 similarly supports and facilitates rotational extension of hex key wrenches 226, 228, 230 and 232. These latter wrenches preferably lay across a bottom portion of the tool holder 176 when not in use. Curvilinearly extending slots 234, 236 and 238 in the rail supports 206, 208 provide clearance to facilitate user selection of the respective wrenches during use of the assembly 170. While hex key wrenches are illustrated, it will be appreciated that any number of different style(s) of tools can be incorporated with the tool holder 176 as set forth above.

In this way, the tool holder 176 and the tool holder support structure 174 preferably form an interchangeable subassembly that can be substituted with other similar subassemblies and used with the same handle 172. Alternatively and/or additionally, the interchangeable subassemblies can be stand-alone tool sets configured to operate with a suitable user supplied driver mechanism.

While the embodiments of FIGS. 17-21 have been preferably provided with a removable handle 172, it will be appreciated that such is not necessarily required. In an alternative preferred embodiment, the handle 172 is permanently joined with the tool holder support structure 174; for example, the driver head 192 of FIG. 19 can be configured to permanently engage the socket aperture 194 in FIG. 20. Similarly, each of the above other preferred embodiments set forth in FIGS. 1-16 can also be readily configured to have a removable handle, as desired.

It will now be appreciated that the various preferred embodiments set forth herein provide advantages over the prior art. The pivotal characteristics of the tool holder (whether via fixed pin or via manual manipulation by the user) allows either end of the tool holder to be easily and efficiently presented for use.

The hinged coupling of the handle to the ratchet mechanism preferably facilitates extension and activation of the selected driver in a number of different environments, including tight fitting spaces. While it is contemplated that maximum torque efficiency is gained through user manipulation of the handle while disposed substantially normal to the tool holder (such as shown in FIG. 3), it will be appreciated that other handle angles, including orienting the handle so as to be substantially axially aligned with the tool holder, can also be used depending on the requirements of a given application.

Another advantage of the various preferred embodiments is the ability to provide a number of different tool holder cartridges that can be selectively engaged with the support structure. For example, spring loaded pins can be used to allow quick coupling and decoupling of the tool holders with the associated support structure.

It is to be understood that even though numerous characteristics and advantages of various embodiments of the present invention have been set forth in the foregoing description, this detailed description is illustrative only, and changes may be made in detail, especially in matters of structure and arrangements of parts within the principles disclosed herein to the full extent indicated by the broad general meaning of the terms in which the appended claims are expressed.

1. An apparatus comprising a handle portion hingedly affixed to a ratchet mechanism, a tool holder support structure aligned with and rigidly affixed to the ratchet mechanism opposite the handle portion, and a tool holder supported by the tool holder support structure and comprising opposing first and second ends each configured to support at least one respective tool.

2. The apparatus of claim 1, wherein the tool holder is further configured so that as the first end is axially aligned with and extends away from the ratchet mechanism so that rotational actuation of the handle portion by a user in a first direction transfers torque to a selected tool supported by the first end in the first direction and rotational actuation of the handle portion by the user in a second opposite rotational direction does not transfer torque to said selected tool.

3. The apparatus of claim 1, wherein the tool holder is configured to rotate about a pivot with respect to the tool holder support structure.

4. The apparatus of claim 1, wherein the tool holder is configured to slidingly engage the tool holder support structure along an engagement axis parallel to a rotational axis of the ratchet mechanism.

5. The apparatus of claim 1, wherein the tool holder is configured to be laterally engaged with the tool holder support structure in a direction substantially normal to a rotational axis of the ratchet mechanism.

6. The apparatus of claim 1, wherein the tool holder further comprises a first tool hingedly affixed to the first end thereof.

7. The apparatus of claim 5, wherein the tool holder further comprises at least one additional tool hingedly affixed to the first end thereof.

8. The apparatus of claim 5, wherein the tool holder further comprises a second tool hingedly affixed to the second end thereof.

9. The apparatus of claim 1, wherein the tool holder comprises an engagement socket configured to retain a driver bit, the engagement socket disposed at the first end of the tool holder.

10. The apparatus of claim 9, wherein the tool holder further comprises a second engagement socket configured to retain a driver bit, the second engagement socket disposed at the second end of the tool holder.

11. The apparatus of claim 1, wherein the tool holder support structure further comprises a retention mechanism that retains the tool holder so that the first and second ends are substantially aligned with a rotational axis of the ratchet mechanism.

12. The apparatus of claim 1, wherein the handle portion and the tool holder support structure are configured so that the tool holder support structure can be folded into a nesting relationship with the handle portion when the apparatus is not in use.

13. The apparatus of claim 1, wherein the handle portion and the ratchet mechanism cooperate to form a handle assembly configured to be removeable from the tool holder support structure.

14. The apparatus of claim 13, wherein the ratchet mechanism comprises a driver head that engages a corresponding driver aperture in the tool holder support assembly, wherein removal of the handle assembly comprises disengagement of the driver head from the driver aperture, and wherein the driver aperture is configured to accommodate insertion of a driver head of a separate driver tool to apply torque the ratchet mechanism.

15. The apparatus of claim 14, wherein the driver aperture is square to accommodate a square driver head of a separate socket driver.

16. The apparatus of claim 1, wherein the tool holder support structure is substantially u-shaped with a base portion that mates with the ratchet mechanism and opposing leg portions that support a medial portion of the tool holder.

17. The apparatus of claim 16, further comprising a pivot pin that respectively extends through the opposing leg portions of the tool holder support structure and the medial portion of the tool holder to facilitate selective rotation of the tool holder with respect to the tool holder support structure.

18. The apparatus of claim 17, wherein the tool holder comprises opposing rail supports that extend along a length of the tool holder adjacent the leg portions of the tool holder support structure and first and second retention pins that extend between the rail supports at opposing ends thereof, each of the first and second retention pins securing and facilitating selective extension of at least one tool mounted for pivotal movement thereto.

19. The apparatus of claim 1, wherein the handle portion comprises opposing flanges that extend from a handle body and which rotatably secure the ratchet mechanism to the handle portion, and user grippable flanges that extend from the handle body adjacent a distal end of the tool holder support structure opposite the ratchet mechanism to facilitate movement of the handle portion from an open position to a closed position.

20. An apparatus comprising a handle portion hingedly affixed to a ratchet mechanism, and first means for selectively presenting each of a plurality of oppositely extending tools for rotation through application of torque to the ratchet mechanism by way of the handle portion.

21. The apparatus of claim 20, wherein the first means comprises a tool holder support structure aligned with and rigidly affixed to the ratchet mechanism opposite the handle portion, and a tool holder supported by the tool holder support structure and comprising opposing first and second ends each configured to support at least one respective tool of said plurality of tools.
